(19) United States
(12) Patent Application Publication
(10) Pub. No.: US 2012/0043750 A1
(43) Pub. Date: Feb. 23, 2012

(54) System and method for the authentication of physical documents

(75) Inventor: Itzhak Raz, Yavne (IL)

(73) Assignees: Itzhak Raz, Yavne (IL); Kenneth Neil Rozenberg, Suffern, NY (US); Dov Ehrman, Brooklyn, NY (US)

(21) Appl. No.: 12/859,486

(22) Filed: Aug. 19, 2010

(51) Int. Cl. B42D 15/00

(52) U.S. Cl. 283/85

(57) ABSTRACT

The invention relates to a system for authenticating a printed document, said document being printed on a substrate which includes plurality of electromagnetic responsive targets that are introduced to the substrate during its manufacturing process and randomly distributed therein, and wherein each target having a fiber form, said system comprises an authentication apparatus which comprises: (a) one transmitting antenna and one receiving antenna that are positioned above a moving conveyor, for radiating an original document during a scanning period in which the conveyor moves the document below said transmitting and receiving antennas; (b) a transmitter for providing electromagnetic signal to said transmitting antenna, and a receiver for receiving from said receiving antenna a responsive electromagnetic signal, said responsive signal being an accumulative response from plurality of said targets as obtained during said scanning period; (c) a sampling unit for sampling said accumulated responsive signal, thereby to produce a set of signal samples; and (d) a processing unit for analyzing one or more aspects of said signal samples, resulting with a set of one characterizing matrix for each aspect of said analyzed signal, wherein the collection of all said matrices forms an original set of characterizing matrices that characterize the substrate of this specific document; and the system also comprises a safe storage for storing said original set of characterizing matrices for possible future need for authenticating this specific document.

### FIELD OF THE INVENTION

The invention relates in general to the field of authentication of physical (non-electronic) documents. More specifically, the invention relates to a system and apparatus for authenticating physical documents, such as legal papers, bank notes, certificates, etc.

### BACKGROUND OF THE INVENTION

The present invention relates in general to the authentication of non-electronic documents. The terms “physical document” or “paper document”, or simply “document” that are used interchangeably herein, refer to physical, non-electronic documents. Such non-electronic documents may be made, for example, from paper, plastic, or other similar materials, or from a combination of several materials. Therefore, when the term “paper” or “substrate” are used herein, they refer to any type of material which forms a substrate on which the content of the document is printed.

Millions of paper documents are issued every day throughout the world. Many of these documents are original, signed documents, whose content is important and valuable, for future use. Therefore, for such documents it is extremely important to secure their exact content, and validity, and moreover, to enable a reliable authentication of the documents whenever necessary. Documents of such type are, for example, those having financial values (for example, bank notes), documents having legal values (such as agreements, contracts, etc.), certificates, etc.

Throughout the years, various procedures have been developed in order to secure validity of documents. For example, various elements, for example, watermarks, or polarized elements, have been introduced into the substrates of documents in order to make them being hard to counterfeit. Various devices have also been developed throughout the years in order to determine the authenticity of such hard to counterfeit documents. Such elements for preventing counterfeit are mostly used in valuable documents. Elements for preventing counterfeit such as watermarks, or polarized elements are typically introduced identically in mass documents of same type, such as currency bills. The fact that they are introduced identically in the mass documents of same type, simplify the structure of the devices for validating them. However, such validation devices are not capable for authenticating unique single paper documents, each having its own value (such as a contract, assignment, a bank note, etc.).

For example, a typical problem that arises frequently relates to the services that are provided by notaries. In a typical case, a person who holds a document comes to a notary, introduces a document to him, and asks him to notarize it. The notary inspects the document, and whenever he is convinced that the document is authentic, he makes a copy, provides to it an ID number, and stamps it by a special, notary stamp. At that stage, the notarized copy can be treated as being the “original” authentic document. Then, the original document is returned to the document holder, together with its notarized copy. The notary makes another copy of the notarized document which is typically kept in a safe place for future verification. From this moment, the document holder can submit the notarized document to any institute, and such a document is recognized and treated like an original (authentic) document. The verification of the original document requires from the notary a very significant responsibility. On one hand, the notary is provided with a paper which looks like an authentic document. On the other hand, the notary has no means or instruments for verifying that the so called “authentic” document is indeed the exact same document which has been originally issued to the document holder (both in terms of the document substrate and in terms of the document printed content).

It should be noted that there are typically two types of counterfeit that a notary may face:
a. The document is a “copy” of an authentic document. More specifically, the authentic document is a re-produced document on a substrate (such as paper) which looks very similar to the paper of the original document, for the purpose of presenting the copied document instead of the authentic one. This type of counterfeit will be referred to herein as “first type” of counterfeit;
b. The authentic document is counterfeited by changing its printed content. For example, a contract which includes a printed sum of US$20,000 may be counterfeited to include a sum of US$200,000. This type of counterfeit will be referred to herein as “second type of counterfeit”.

The fast development of the printing technology in the recent years, which now enables the use of very high quality of printing and printing substrates at almost every home, together with a significant reduction of printers cost, cause the act of counterfeit of documents be in many cases a relatively easy task.

As noted above, in order to counterfeit a document, one does not necessarily has to obtain a physical substrate which looks exactly like the original one and has the same characteristics of the original physical substrate. A counterfeit of a document can be performed on the original physical paper, by counterfeiting its content (i.e., by changing the printed data on the document—see above the “second type” of counterfeit). It should be noted that in some cases a counterfeit of a document may involve combination of said two types of counterfeit.

The above examples illustrate the difficulties that a notary faces while verifying the authenticity of a document. This is only one example, as such difficulties arise with respect to millions of documents that are produced or processed every day throughout the world.

U.S. Pat. No. 5,581,257 (Greene) discloses a substrate which includes plurality of radio (electromagnetic) responsive “targets”, each having a form of a very thin fiber. The radio responsive targets are any radio frequency responsive means which may be attached to, printed on, or otherwise associated with the substrate to be identified. In one embodiment, the substrate with the randomly disposed targets forms a special physical paper on which visual data can be printed or written like on a typical paper. According to Greene, this physical paper can be authenticated. Greene proposes a method and apparatus for authenticating said physical paper in which said targets are embedded. Initially, the paper is scanned by an RF apparatus using RF transmitting and receiving antennas, and the exact location and orientation of each target is determined and recorded. Then, at some future time, when authentication of the document is required, the paper is “scanned” again, and the location of the embedded targets is again determined. A comparison between the locations of all individual targets, as determined by said two scanning procedures, shows whether the substrate is authentic or not.

U.S. Pat. No. 5,291,205, also by Green, suggests another method and apparatus for determining the authenticity of a substrate. In this patent, Green suggests randomly embedding within the substrate targets of different lengths. Therefore, each of the targets has a different resonance frequency. Green suggests radiating the substrate by an RF signal, whose frequency linearly changes within a predetermined range in a saw tooth manner. Therefore, upon radiation of the substrate, the various responses from the separate targets appear within said predetermined spectrum of the RF signal. The spectrum of the response, as obtained from the first scanning procedure of the authentic document, is recorded. In the future, the same scanning procedure is repeated, and a second spectrum response is obtained. A comparison between the two scanning procedures shows whether the substrate of the document which is scanned during the second procedure is indeed authentic or not.

The systems and apparatuses as disclosed in U.S. Pat. No. 5,581,257 and U.S. Pat. No. 5,291,205 try to determine the exact location or spectrum response with the resolution of the individual target level. More specifically, U.S. Pat. No. 5,581,257 tries to locate and subsequently verify the exact location and orientation of each and every target which is randomly embedded within the substrate, and U.S. Pat. No. 5,291,205 tries to receive a separate response from each and every target which is randomly embedded within the substrate. Unfortunately, it has been found by the inventors of the present invention that it is extremely difficult, essentially impossible to exactly “map” a physical substrate in terms of the random distributed targets therein, with the resolution of the individual target. More specifically, it has been found that it is essentially impossible to determine the exact location of said targets within the substrate. Furthermore, it has been found that also the method and apparatus of U.S. Pat. No. 5,291,205 is not practical, as it is essentially applicable only when very few fibers are disposed within the substrate, and in that case, the substrate can be relatively easily counterfeited.

Furthermore, Greene does not disclose a manner by which a document can be fully authenticated, including the substrate itself and its associated printed or written data.

Hereinafter in this application, if not otherwise stated specifically, the terms “paper”, or “physical paper” or “substrate”, relate to a special physical substrate such as disclosed in U.S. Pat. No. 5,581,257, in which targets (also referred to herein as “fibers”) of various dimensions are embedded randomly. It should be noted that the targets are generally fibers that are made of metal, and have a diameter in the order similar to a human hair, or even less. It should also be noted that the targets may be introduced into the pulp of the substrate, at the early stages of substrate production. Hereinafter, the terms “printed document” and “written document” are used interchangeably, referring to a document which includes visual printed or written data. Furthermore, when the term “data” is used with respect to a document, said term relates both to written or printed data on a document.

It is therefore an object of the present invention to provide a method, apparatus, and system for the full authentication of a printed document, wherein said document authentication includes authentication of both the document substrate and its associated printed data.

It is still another object of the present invention to enable authentication of said document in very secured and reliable manner.

It is still an object of the present invention to provide said apparatus, system, and method that can easily, reliably, and immediately detect counterfeit in either the physical paper or in the data (printed or written) associated with it.

It is still another object of the present invention to provide an authentication system in which it is extremely difficult, essentially impossible, to counterfeit a document.

It is still another object of the present invention to provide a reliable authentication system which is relatively simple and of low cost, which can therefore be used by many types of institutes.

It is still another object of the present invention to provide a system which can authenticate a document from a local or a remote location.

Other objects and advantages of the present invention will become clear as the description proceeds.

### SUMMARY OF THE INVENTION

The invention relates to a system for authenticating a printed document, said document being printed on a substrate which includes plurality of electromagnetic responsive targets that are introduced to the substrate during its manufacturing process and randomly distributed therein, and wherein each target having a fiber form, said system comprises an authentication apparatus which comprises: (a) one transmitting antenna and one receiving antenna that are positioned above a moving conveyor, for radiating an original document during a scanning period in which the conveyor moves the document below said transmitting and receiving antennas; (b) a transmitter for providing electromagnetic signal to said transmitting antenna, and a receiver for receiving from said receiving antenna a responsive electromagnetic signal, said responsive signal being an accumulative response from plurality of said targets as obtained during said scanning period; (c) a sampling unit for sampling said accumulated responsive signal, thereby to produce a set of signal samples; and (d) a processing unit for analyzing one or more aspects of said signal samples, resulting with a set of one characterizing matrix for each aspect of said analyzed signal, wherein the collection of all said matrices forms an original set of characterizing matrices that characterize the substrate of this specific document; and the system also comprises a safe storage for storing said original set of characterizing matrices for possible future need for authenticating this specific document.

Preferably, the analysis is performed at the time domain, frequency domain, or both.

Preferably, the types of analyses comprise one or more of: Zero Crossing Ratio, Linear Predictive Coding, Prony, Shape Imitation Process, Frames Correlation, Fast Fourier Transform, and Phase.

Preferably, the apparatus further comprises an optical scanning unit for optically scanning the printed document, obtaining one or more of optical characterizing matrices which characterize the printed content of the document, and adding said optical characterizing matrices to said original set of characterizing matrices for future comparison.

Preferably, the system further comprises an authentication processing center, which comprises: (a) an authentication apparatus as in claim 1 for scanning a document at a later date and obtaining a later set of characterizing matrices; (b) a retrieval unit for retrieving said original set of characterizing matrices from said safe storage; and (c) a comparator for comparing said later set of characterizing matrices with said original set of characterizing matrices that presumably corresponds to a same document, and if a similarity above a predefined threshold is found, declaring said scanned document as authentic, otherwise declaring the scanned document as non-authentic.

Preferably, the authentication apparatus which performs the original examination of the document further stamps the original document with document code for ensuring a reliable future retrieval of the original set of characterizing matrices and reliable comparison, and wherein said document code comprises one or more of: (a) the apparatus version by which the original examination was performed; (b) the serial number of the original examining apparatus; (c) a serial number of the authentic original document; (d) the date of examination; or (d) an integrity index.

Preferably, the document code is visually seen.

Preferably, the document code has a form selected from the group of barcode or alphanumeric.

Preferably, the authentication processing center is located remote from said safe storage, and wherein the characterizing matrices are transferred for comparison via a secured link.

Preferably, the comparison is performed at the location of the safe storage, or at the location of the authentication processing center.

Preferably, the frequency of the transmitting signal is in the range of 24 GHz or 60 GHz.

Preferably, the sampling rate is at least 1 KHz.

### BRIEF DESCRIPTION OF THE DRAWINGS

In the drawings:

FIG. 1a shows a prior art physical paper, of the type as disclosed in U.S. Pat. No. 5,581,257;

FIG. 1b shows the prior art physical paper of FIG. 1, in which the targets are distorted;

FIG. 2a shows an exemplary assignment (agreement) document which is printed on the paper of FIG. 1b;

FIG. 2b shows the document of FIG. 2a, as examined by the machine and process of the invention, with its document code at the bottom;

FIG. 3a generally illustrates the physical aspect of the authentication process used by the present invention;

FIG. 3b generally illustrates the authentication process of the invention;

FIG. 3c illustrates in block diagram form the general structure of an apparatus 10 for authenticating a substrate, according to an embodiment of the present invention;

FIG. 4 illustrates in block diagram form the authenticating apparatus according to a more preferred embodiment, which fully authenticates a document including the substrate and the document content;

FIG. 5 illustrates in block diagram a laboratory implementation of the authentication system of the present invention;

FIG. 6 shows 10 waves results, superimposed one on the others, that have been obtained while testing a paper #1 in 10 different occasions, while using Matlab;

FIG. 7 shows other 10 waves results, superimposed one the others, that have been obtained while testing another paper, paper #2 in 10 different occasions, and using Matlab;

FIG. 8 shows still other 10 waves results, superimposed one the others, that have been obtained while testing a third paper #3 in 10 different occasions, and using Matlab;

FIG. 9 illustrates a system and a procedure for remote authentication of physical documents according to an embodiment of the present invention; and

FIG. 10 shows a resulted phase, as obtained from three different pages, P1, P2, and P3.

### DETAILED DESCRIPTION OF PREFERRED EMBODIMENTS

As mentioned above, U.S. Pat. No. 5,581,257 (Greene) discloses a substrate which includes plurality of radio frequency responsive targets (“fibers”) that are embedded randomly within it, printed on it, or otherwise attached to it. The targets typically have a random length of several millimeters, and a diameter in the order of a human hair or less.

In one embodiment of Greene, The targets are introduced into the mixture of the substrate during the early stages of its production process, and therefore the final positions and orientations of the targets are become random within the final substrate (having a form of a paper), and therefore each final paper has a unique distribution and number of said targets. As also mentioned in the “Background of the Invention” section above. In a learning stage, Greene determines the location and orientation of each and every target within the substrate. This is done, for example, by dividing the paper into grids (columns and rows), and the learning stage informs the location and orientation of each element. In the later authentication stage, Greene proposes verifying whether all targets indeed exist at the exact specific locations as determined at the earlier learning stage (see, for example, col. 14 lines 34-56). Such a machine which verifies the exact location of each and every target within the document is shown, for example in FIG. 14 of Greene.

The targets themselves are essentially fibers, having a diameter in the order of a human hair or less, and a typical length in the order of several millimeters. The length and/or diameter of the various targets may not be the same, and in some cases, the differences in length and/or diameter between the various targets are advantageous for providing uniqueness to each substrate. Moreover, generally the production process of the substrate causes distortions to the targets that are embedded within the substrate.

As was also mentioned hereinabove, it has been found by the inventors of the present invention that it is extremely complicated, if not absolutely impossible to determine the exact location and orientation of each and every individual radio frequency target which is embedded within a substrate. Furthermore, it has been found that it is extremely difficult to differentiate between various substrates by means of obtaining the resonant frequency response from each individual target.

The present invention suggests a method and apparatus that can reliably authenticate such a physical paper (i.e., substrate), although the location, orientation, and or resonance frequency of each individual target is not determined. More specifically, the present invention is based on measuring the cumulative response from plurality of targets within the substrate, without the need to analyze the response from each individual target.

Moreover, the apparatus of the present invention reliably authenticates the validity of the entire document, including the physical paper and the document content (i.e., the data which is printed or written on it).

A convention printed document is a monolithic (inseparable) product which combines a substrate and a printed matter. The present invention assumes the use of a substrate as disclosed, for example, in U.S. Pat. No. 5,581,257, in which “targets” having a fiber form are either introduced to the paper during its manufacturing process or otherwise introduced to the final product (substrate) later on, such as by means of gluing, printing etc. The printing of a subject matter on a substrate forms a new product, hereinafter, a “printed document”, which the present application can authenticate. The invention looks at the printed document as a single product, that is examine by several wavelength processes of electromagnetic wavelength, and optical wavelength.

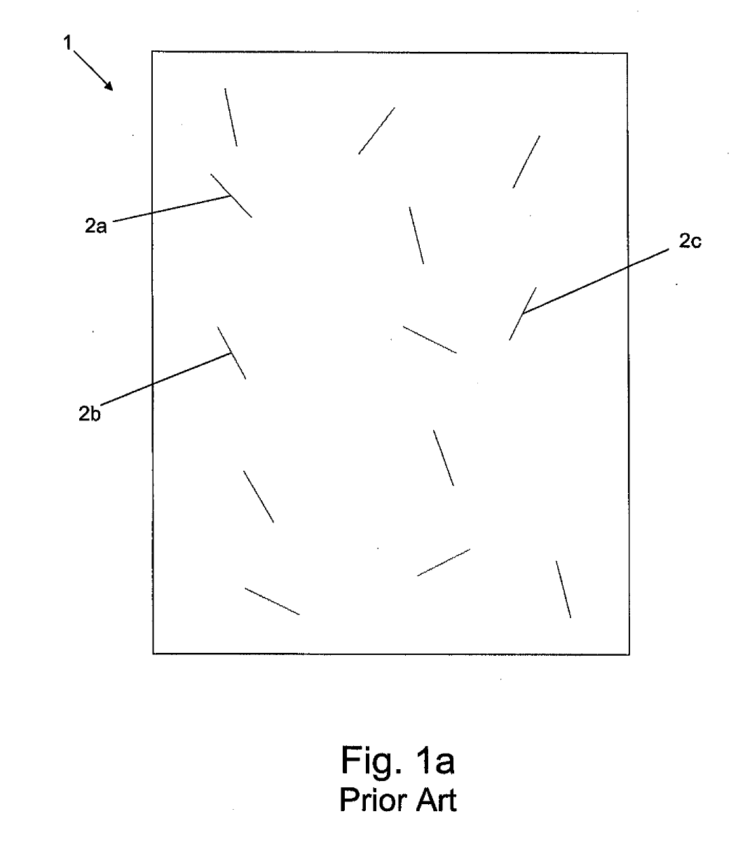

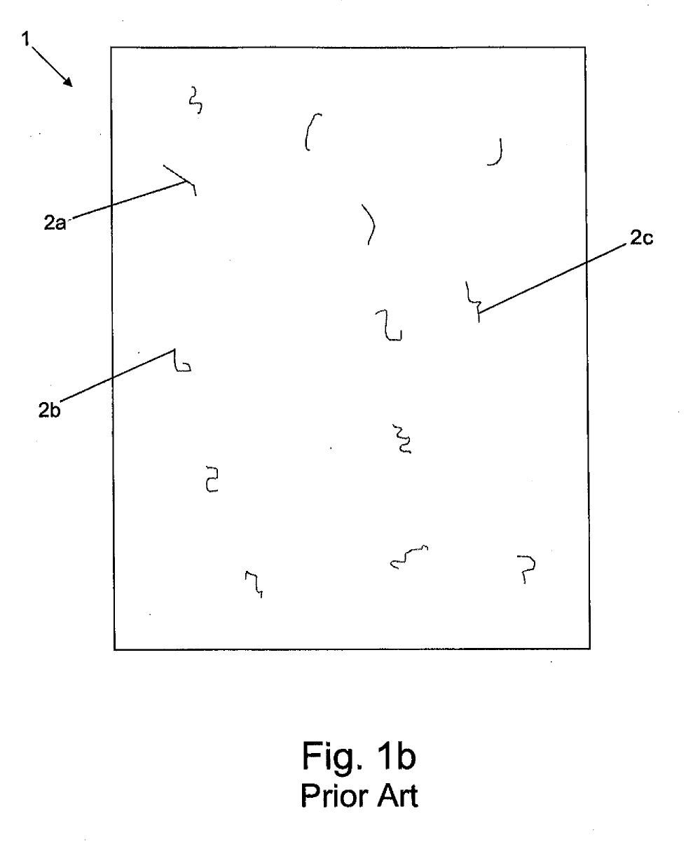

FIG. 1a shows a physical paper 1, of the type as disclosed in U.S. Pat. No. 5,581,257 (Greene). Practically, the targets within the final substrate do not have a straight form as shown in FIG. 1, but they are distorted during the production process, and receive a distorted form like the one shown in FIG. 1b. The present invention uses a paper as in FIG. 1b. The paper looks essentially the same as a conventional paper, and functions for the end user who prints on the paper or reads the paper essentially the same. However, as mentioned the paper includes plurality of targets 2a, 2b, . . . 2n that are randomly embedded within the paper substrate or otherwise attached to it.

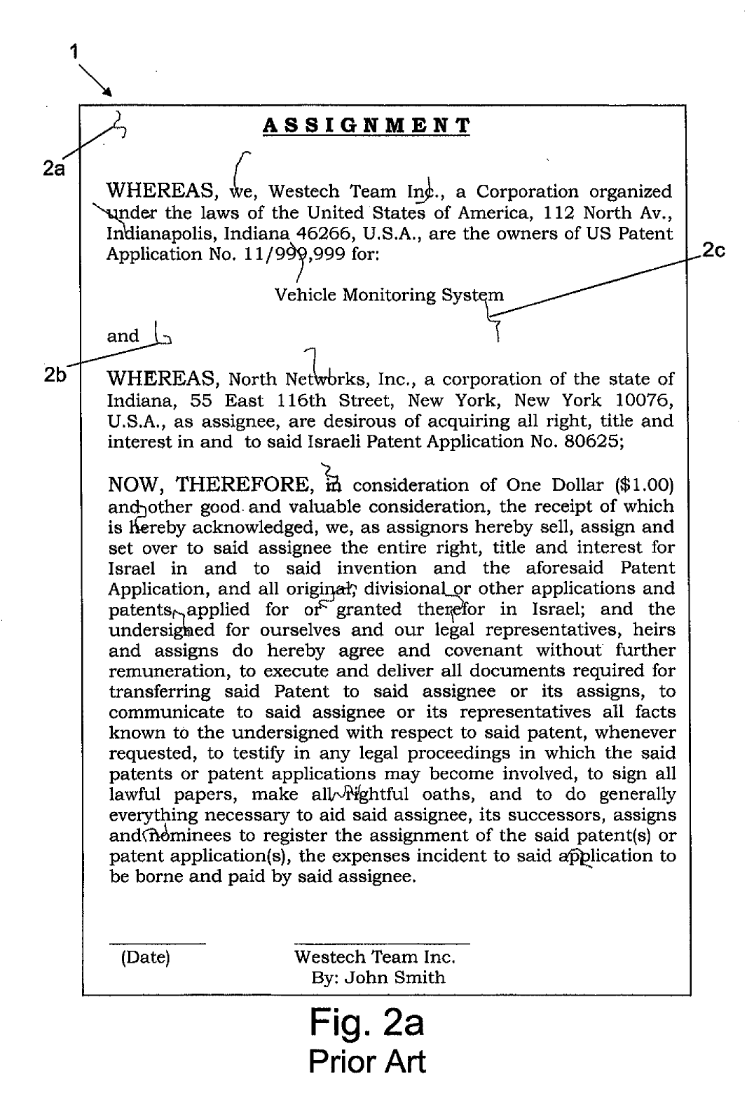

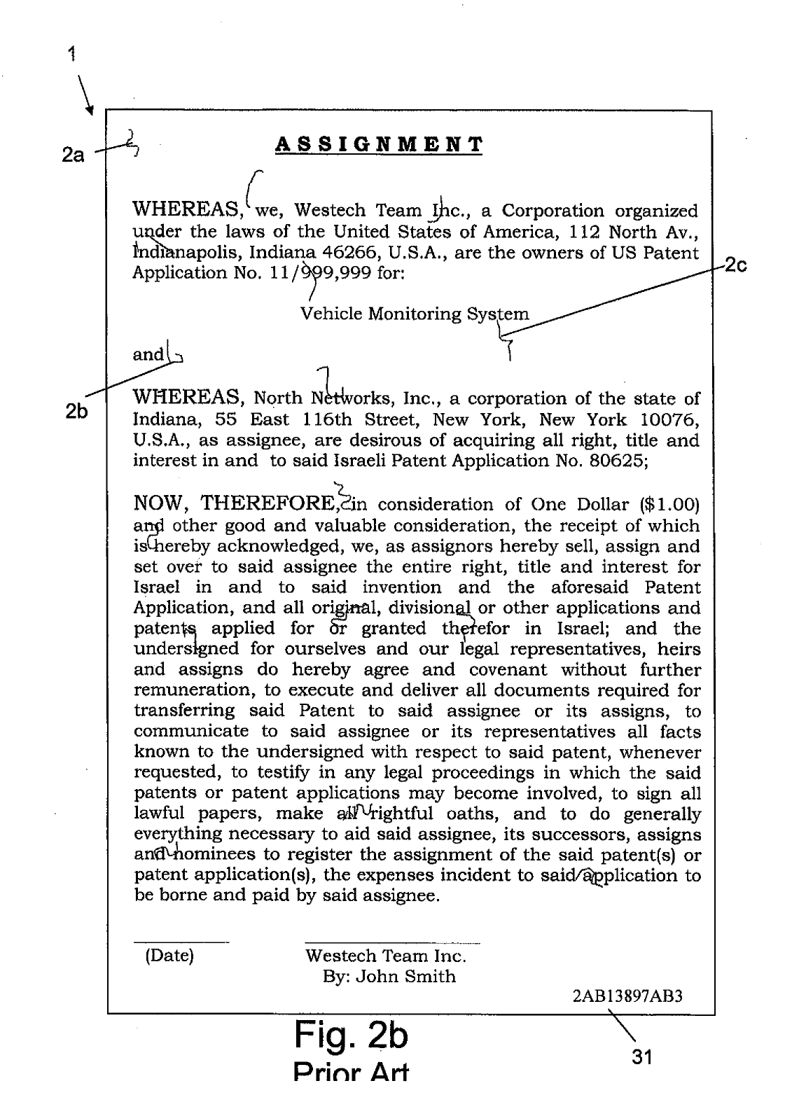

FIG. 2a shows an exemplary assignment (agreement) document which is printed on the paper of FIG. 1b. Although the agreement content and the targets are both shown for the purpose of illustration, generally the document looks like a conventional paper document, and the targets that are randomly embedded within the physical paper are not visually seen.

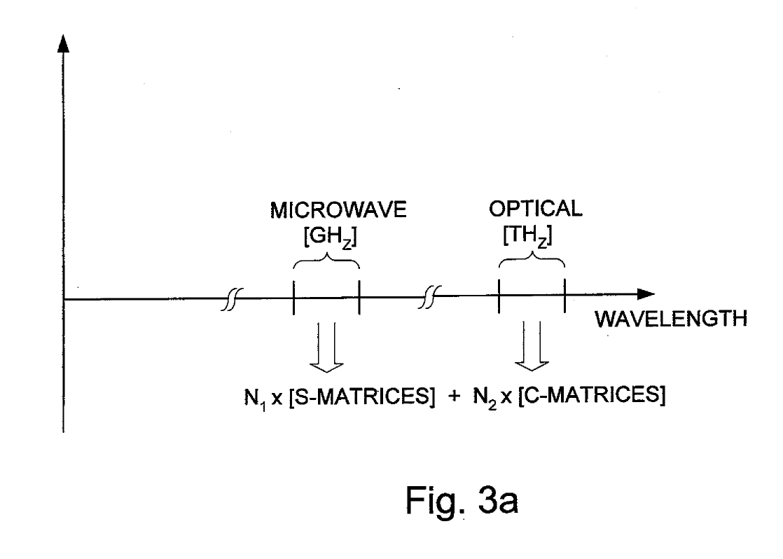

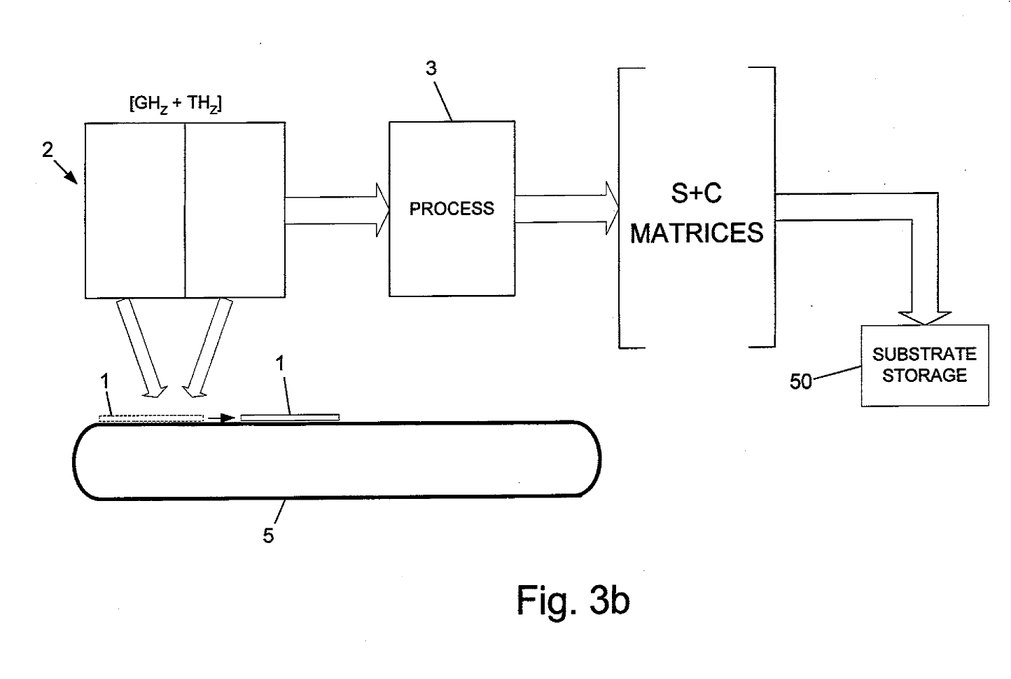

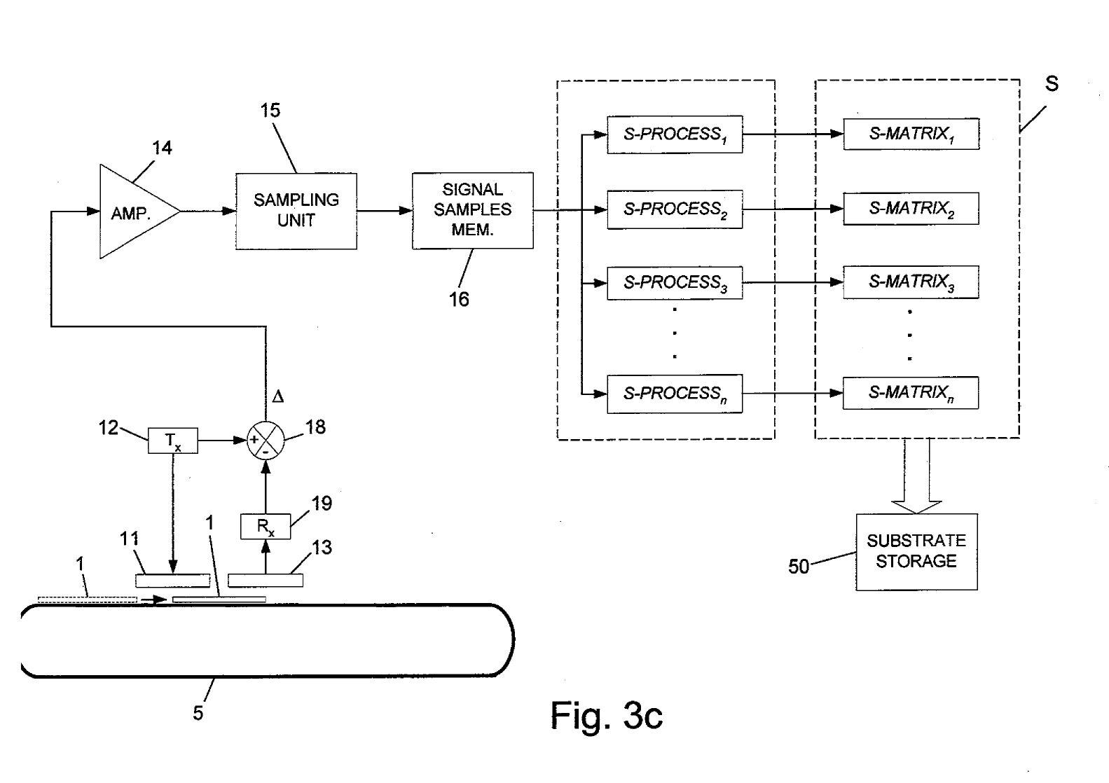

The process of the present invention can be used to authenticate either only the substrate of the printed document, or to fully authenticate the monolithic printed document (i.e., both the substrate and the document content). FIG. 3a generally illustrates the physical aspect of the authentication process used by the present invention. As shown in FIG. 3a, the present invention uses different wavelengths ranges in the authentication process to create a set of matrices that represent the printed document. A first sub-set of S-matrices is a result of applying microwave wavelength (preferably in the GHz range], and a second sub-set of C-matrices is a result of applying optical wavelength (preferably in the THz range]. However, the present invention allows using only the microwave range with the S-matrices to authenticate the substrate only.

FIG. 3b generally illustrates the authentication process of the invention. Paper 1 is introduced onto conveyor 5, that moves the paper in order to scan it in different wavelengths [GHz+THz] by scanning unit 2. The outcome of the scanning unit 2 is conveyed into mathematical process 3. Mathematical process 3 produces a set of matrices [S-Matrices+C-Matrices], that are stored in safe substrate storage 50.

FIG. 3c illustrates in block diagram form the general structure of an apparatus 10 for authenticating a substrate, according to an embodiment of the present invention.

The apparatus comprises a moving conveyor 5 on which the substrate 1 is positioned. The apparatus further comprises a transmitter 12 which transmits an RF signal by means of transmitting antenna 11. Said RF signal is typically in a range of microwave, for example, 24 GHz. In another alternative, the frequency may typically be, for example, 60 GHz. The frequencies are preferably chosen to conform with the regulations for assigning frequencies by the authorities. The apparatus further comprises a receiving antenna 13, and a receiver 19 which receives a returned (reflected) cumulative signal from substrate 1. The term “cumulative” indicates that the returned signal is a function of simultaneous returns (reflections) from plurality (some times many, for example, tens) of fibers within the inspected substrate or a portion thereof, and that there is no need to separate or analyze any individual response from any specific fiber or refer to the individual fibers shapes or distortions. It has been found by the inventors that the movement of the document relative to the fixed transmitting and receiving antennas 11 and 13 respectively produces a cumulative signal, which changes in time in a manner which depends on the random amount and distribution of the fibers 2a-2n within the substrate. The received signal is provided into mixer 18 which simultaneously also receives a respective transmitter signal from transmitter 12. The output of the mixer is a difference signal between the receiver 19 signal and the transmitter 12 signal. The difference signal is a low frequency signal, typically in a frequency less than 1 KHz which is conveyed into amplifier 14. Amplifier 14 amplifies the signal, and transfers the same into sampling unit 15. Sampling unit 15 periodically samples the amplified signal at a rate, typically 1 KHz and more, for example between 1 KHz and 10 KHz, and stores the signal samples at memory 16. The samples form a basic signal subset which characterizes the “RF scanned” document 1. As will be described hereinafter, the basic subset of samples by itself is generally not sufficient for describing the uniqueness of a substrate, or more specifically, to distinguish it from many others (may be millions) of similar substrates. Therefore, in order to provide an enhanced distinction, the present invention applies on said samples a set plurality of signal processes. Each of said signal processes 1-n analyzes in depth one aspect of the signal, and said analysis results in a corresponding substrate matrix s-matrix₁-s-matrixₙ. The combined set of all said separate substrate matrices forms a characterizing substrate matrix S of the document, which is stored for future authentication use.

Each of the individual processes s-process₁-s-processₙ performs a separate analysis of the signal, in the time domain, frequency domain, or both. For example, s-process₁ may perform a Fast Fourier Transform, resulting in an FFT s-matrix₁. S-process₂ may square the samples, resulting in an energy s-matrix₂. S-process₃ may summarize the zero crossings of the signal, etc. Additional processes may also be applied in a similar manner, in order to increase accuracy of the authentication. The matrix S which comprises all the subset matrices s-matrix₁-s-matrixₙ is therefore the substrate characterizing matrix which is used for authenticating the substrate. As will be discussed in more details hereinafter, the characterizing matrix S is preferably expanded to form a document matrix D which includes, in addition to the set of substrate matrices s-matrix₁-s-matrixₙ, one or more content matrices c-matrix₁-c-matrixₙ that provide exact representation of the content which is written and/or printed on the original substrate. In that case, the combined matrix D which characterizes both the substrate and the document content uniquely and completely characterizes the full document (i.e., the substrate and its content), and can therefore be used for future full authentication of the document. More specifically, the matrix D can detect as to whether the document has been subjected to a first type and/or second type of counterfeit (as listed above in the “Background of the Invention” section).

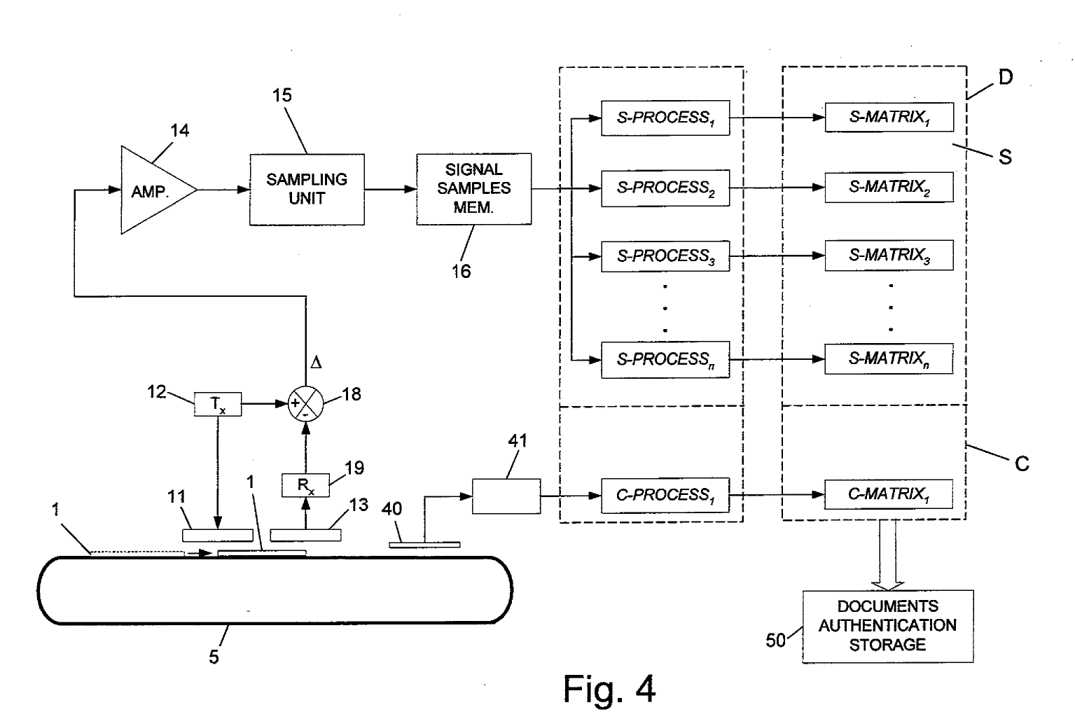

FIG. 4 describes the authenticating apparatus according to a more preferred embodiment, which fully authenticates the document including the substrate and the document content. The apparatus of FIG. 4, contains, in additional to the apparatus structure of FIG. 3c, means for ensuring authentication of the document content. Said content authentication means comprises a typical optical scanner 40 which scans the document, and produces a typical graphical (such as TIF, JPG, PDF, etc.) file 41 which fully describes the document content. The graphical file 41 is provided into c-process1, which analyzes the file, and produces a mathematical expression c-matrix₁. The c-matrix₁ forms a part of document matrix D, which combines the substrate matrix S and the content matrix C. The physical original document is then stamped by an alphanumeric visible code (hereinafter “document code”, or “apostil”). Said document code indicates that this document has been examined for future authentication. The code may include one or more of the following: (a) the apparatus (also referred to herein as “machine”) version by which the examination was performed; (b) serial number of the examining machine; (c) serial number of the authentic document; (d) the date of examination; (d) an integrity index which relates to the code, and is a function, for example, CRC of the rest of the elements (a-c) of the code. FIG. 2b shows the document, as examined, with its document code 31. In one alternative, the document code may have barcode form presentation.

The document matrix D together with said document code is stored in an authorized safe storage 50 (which generally stores many document matrices) for future authentication.

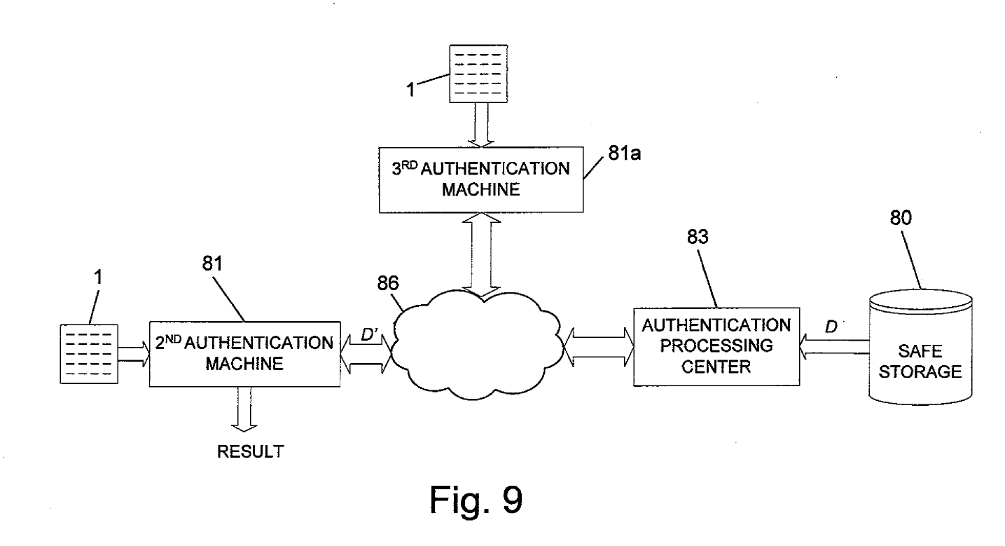

FIG. 9 illustrates a system and a procedure for remote authentication of physical documents according to an embodiment of the present invention. When a necessity to authenticate a document arises at some later date, the document is introduced to a similar second machine 81 which may be located away from the first machine that has initially examined the supposedly same physical document 1. The second machine 81 performs essentially the same procedure as originally performed by the first machine, resulting in a later document matrix D′. This document matrix D′ together with the document code 31 as appears on document 1 are conveyed via network 86 to the authentication processing center 83. The authentication processing center 83 uses the document code 31 to retrieve the respective original document matrix D from the safe storage 80. Authentication processing center 83 compares between matrix D′ and the original matrix D of the supposedly same document. If a match or similarity above a predefined mathematical threshold level is found, the document is declared as authentic. Otherwise, the document is declared as non-authentic, or as a document which requires further inspection and/or analysis. Authentication processing center conveys the declaration result to the document holder via the second authentication machine. The communication between the authentication machines 81 and the authentication processing center is performed as a secured communication.

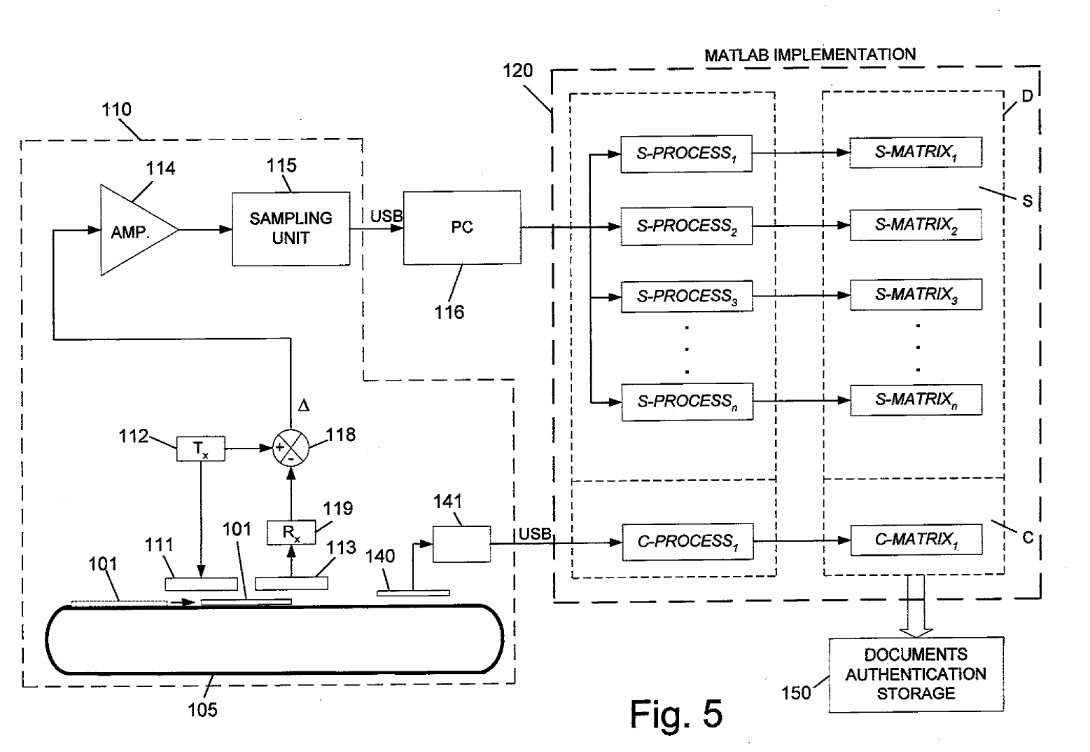

FIG. 5 provides a laboratory implementation of the authentication system of the present invention. The hardware portion 110 of the system has been built and includes:
a. a conveyor 105;
b. a 2 mW transmitter 112 and receiver 119 operating in 24,240 MHz;
c. small size transmitting and receiving antennas 111 and 113 respectively printed on a ceramic substrate;
d. Mixer 118 has been used as integrated circuit within transmitter and receiver units 113 and 119 respectively;
e. Low frequency amplifier 114 has been built as an instrumental amplifier with a gain of 100;
f. Sampling unit 115 has been implemented using a Bitscope (A/D Digitizing module) unit model number BS10000;
g. A Matlab software package 120 with Matlab implementation for creating Mathematical matrices from the samples as obtained by sampling unit 115, and scanner 141;
h. A dual core PC 116 has used for running the coordinating processing and storage;
i. Scanner 141 for optically scanning the document.

The following processes have been applied by the laboratory system of FIG. 5: a. Zero Crossing; b. Energy; c. Linear Predictive Coding (LPC); d. Prony; e. Shape Imitation; f. Envelope Detection; g. FFT (Fast Fourier Transform); and g. Phase shift.

### EXAMPLE 1

The RF transmitter and receiver antennas 111 and 113 respectively having the form of a printed circuit and a size of 3×3 centimeters have been positioned 20 millimeters from the scanner conveyor. The RF signal had a form of a continuous wave, having a frequency of 24,240 MHz, and transmission power of 4 mW. The BitScope sampled the low frequency signal from the mixer 118 at a rate of 1 KHz.

During the experiment, 100 documents having a B4 standard size were positioned on the scanner conveyor and tested, and their results have been recorded. It should be noted that during the experiment both the optical and the RF processes were performed simultaneously.

The PC has used Matlab software to process separately the samples and the optical signals.

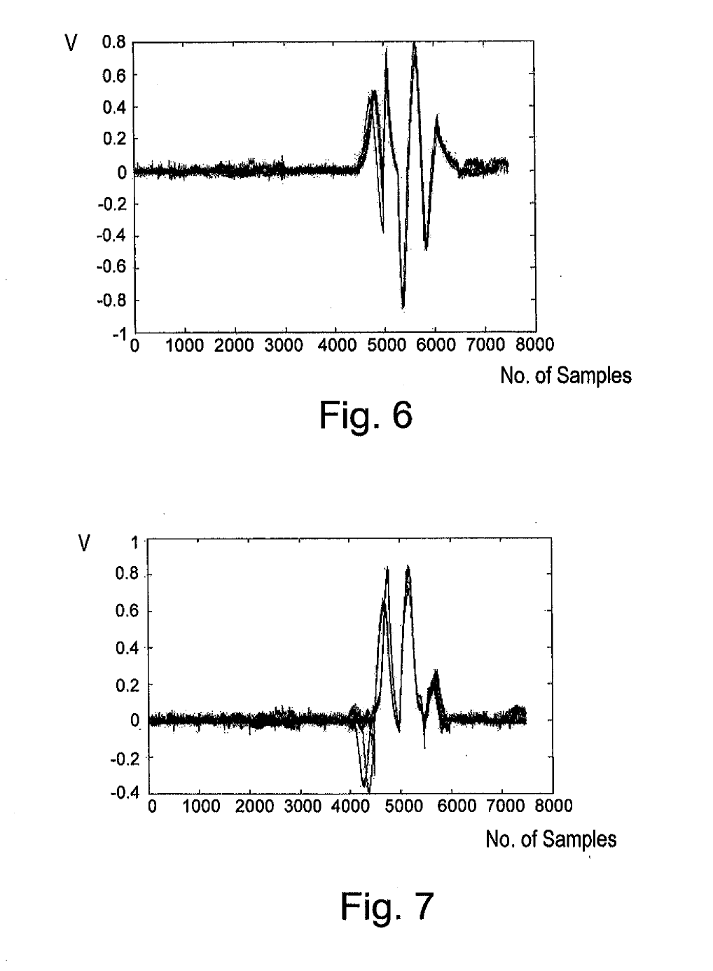

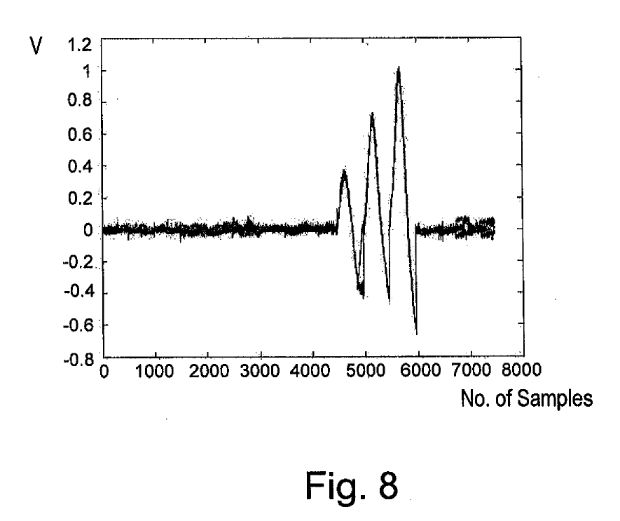

After introduction of about 100 documents into the experimental system of FIG. 5, the results shown that each document has its own typical characteristic matrices, and that the waveforms of the documents were very distinct one from the others. FIGS. 6, 7, and 8 show sampled signals (outputs from sampling unit 115), as obtained from 3 different papers. It is clearly seen that the signals are distinct one from the others. The results have also shown that any repeated introduction of a same paper into the system results in the production of essentially the same signal samples. More specifically, FIG. 6 shows 10 waves results, superimposed one on the others, that have been obtained while testing a paper #1 in 10 different occasions, while using Matlab. FIG. 7 shows other 10 waves results, superimposed one the others, that have been obtained while testing another paper, paper #2 in 10 different occasions, and using Matlab. FIG. 8 shows still other 10 waves results, superimposed one the others, that have been obtained while testing a third paper #3 in 10 different occasions, and using Matlab. The test shows that repetition of the “scanning” of a same paper in 10 various occasions results in essentially a same wave.

Moreover, after testing many papers, each paper several times, the inventors could successfully determine those waves that have been resulted from specific papers, while distinguishing these waves from those that have been resulted from many other papers.

With respect to FIGS. 6, 7, and 8: The information within the Matlab was grouped into frames. Each frame included 500 samples, and 15 frames have been measured during each paper introduction. Out of the 15 frames, the first 9 frames (i.e., until about sample 4500) have measured the conveyor only (without any paper), the next 3 frames (i.e., between 4500 and 6000) have measured the response from the paper, and the last 3 frames (i.e., between 6000 and 7500) have again measured the conveyor only. The 3 frames (i.e., between 4500 and 6000) relate to 4 cm of the paper only.

Analysis Discussion:

As noted above, various processes in the time domain and the frequency domain have been performed with respect to each substrate signal (i.e., with respect to the samples), resulting in a corresponding matrix. The following discussion provides further details with respect to several processes that were used with the laboratory system of FIG. 5.

Time Domain:

a. Energy:

In this process, the energy included in each frame of the sampled signal is summed (as mentioned there are 500 samples per frame, wherein a frame is defined as a subset of samples). This process enables to characterize the “intensity” of each frame in the signal. As shown before, each reflected RF signal has different shape (and therefore energy). Therefore, by this process a numerical matrix is obtained for each frame. The energy is calculated according to equation 1:

$${E}_{frame} = {\sum }_{n = m}^{m = N - 1} {s}^{2} ( n ) \qquad ( 1 )$$

Wherein: m indicates the index of the sample;
N is the size of the frame.

This process is performed over each of the M frames. Therefore, the resulted energy matrix has a size of (M×1).

b. Zero Crossing Ratio (ZCR):

A ZCR process enables characterization of the signal in the time domain. This process determines the number of zero crossings within each frame (i.e., it counts the number of times within each frame in which the signal changes its sign from minus to plus or vice versa). The zero crossing value is determined by averaging each frame, as shown in equation (2):

$$\begin{matrix} {Z}_{s} = E \{ \frac{\vert sgn [ s ( n ) ] - sgn [ s ( n - 1 ) ] \vert}{2} \} \\ sgn [ s ( n ) ] = \{ \begin{matrix}+ 1 & s ( n ) \geq 0 \\ - 1 & s ( n ) < 0\end{matrix} \\ Wherein sgn [ s ( n ) ] represents a change in the signal sign . Therefore , & ( 2 ) \\ {Z}_{s} ( M ) = \frac{1}{N} {\sum }_{n = m - N + 1}^{m} \{ \frac{\vert sgn [ s ( n ) ] - sgn [ s ( n - 1 ) ] \vert}{2} \} w [ m - n ] & ( 3 )\end{matrix}$$

wherein:
w [m−n] is a function that describes the frame to examine;
M is the number of frames;
m indicates the index in the sample frame; and
N is the size of the frame.

This provides the ZCR matrix size (M×1) per paper.
c. LPC or Prony:

LPC (Linear Predictive Coding) is a tool for representing the spectral envelope of a digital signal in compressed form, using the information of a linear predictive model. LPC determines the coefficients of a forward linear predictor by minimizing the prediction error in the least squares sense. It has applications in filter design and speech coding. LPC finds the coefficients of a Pth-order linear predictor (FIR filter) that predicts the current value of the real-valued time signal based on past samples.

ŝ(n)='1a(2)s(n−1)−a(3)s(n−2)− . . . −a(P+1)s(n−P) (4)

Where: p is the order of the prediction filter polynomial,
a=[1 a(2) . . . a(p+1)].
a is the coefficients matrix of the model estimate.

As this process is based on an estimation model, there is a prediction error which is better noticed in the Z domain:

$$S ( w ) = \frac{{G}^{2}}{{\vert 1 + {\sum }_{i = 1}^{P} {a}_{i} \cdot {z}^{- 1} \vert}^{2}} \qquad ( 5 )$$

Where: G is the prediction error variance.

LPC uses the autocorrelation method of autoregressive (AR) modeling to find the filter coefficients. It computes the least squares solution to

Xa≈b (6)

### Where:

$$X = [ \begin{matrix}x ( 1 ) & 0 & … & 0 \\ x ( 2 ) & x ( 1 ) & ⋱ & ⋮ \\ ⋮ & x ( 1 ) & ⋱ & 0 \\ x ( m ) & ⋮ & ⋱ & x ( 1 ) \\ 0 & x ( m ) & ⋱ & x ( 2 ) \\ ⋮ & ⋱ & ⋱ & ⋮ \\ 0 & … & ⋱ & x ( m )\end{matrix} ] ( 3.8 ) a = [ \begin{matrix}1 \\ a ( 2 ) \\ ⋮ \\ a ( P + 1 )\end{matrix} ] ( 3.9 ) b = [ \begin{matrix}1 \\ 0 \\ ⋮ \\ 0\end{matrix} ] \qquad ( 7 )$$

Now, it is possible to solve the least square problem by this known equation:

X^{H} Xa=X ^{H} b (8)

Which leads to the Yule-Walker equations:

$$[ \begin{matrix}r ( 1 ) & r ( 2 ) * & … & r ( P ) * \\ r ( 2 ) & r ( 1 ) & ⋱ & ⋮ \\ ⋮ & ⋱ & ⋱ & r ( 2 ) * \\ r ( P ) & r ( 2 ) & … & r ( 1 )\end{matrix} ] [ \begin{matrix}a ( 2 ) \\ a ( 3 ) \\ ⋮ \\ a ( P )\end{matrix} ] = [ \begin{matrix}- r ( 2 ) \\ - r ( 3 ) \\ ⋮ \\ - r ( P )\end{matrix} ] \qquad ( 9 )$$

Where: r=[r(1) r(2) . . . r(p+1)] is an autocorrelation estimate. The Yule-Walker equations are solved in O(p2) flops by the Levinson-Durbin algorithm. The Levinson-Durbin algorithm is an algorithm for finding an all-pole IIR filter with a prescribed deterministic autocorrelation sequence.

As an alternative the inventors have also tested the use of Prony process. The Prony process is an algorithm for finding an IIR filter with a prescribed time domain impulse response. It has applications in filter design, exponential signal modeling, and system identification (parametric modeling).

$$H ( z ) = \frac{B ( z )}{A ( z )} = \frac{b ( 1 ) + b ( 2 ) {z}^{- 1} + … + b ( n + 1 ) {z}^{- n}}{a ( 1 ) + a 2 {z}^{- 1} + … + a ( n + 1 ) {z}^{- m}} \qquad ( 10 )$$

Where: n is the filter numerator order.
m is the filter denominator order.
h is the time domain impulse response.

Prony returns the filter coefficients in row vectors b and a, of length n+1 and m+1, respectively. The filter coefficients are in descending powers of z.

This process uses a variation of the covariance method of AR modeling to find the denominator coefficients a and then finds the numerator coefficients b for which the impulse response of the output filter matches exactly the first n+1 samples of the signal.

Comparison: The Prony process was compared with the LPC process. The results were almost the same, but LPC is slightly preferable because of the well known weakness of the Prony process in noisy environments. Furthermore, the LPC process has been found to provide faster results for up to order 20.

The LPC process results in a matrix size of (M×P), Where M is the number of frames.

The above processes (A, B, and C) are well known in signal processing, and also well proven in algorithms for speech/voice processing systems. The use of these processes is advantageous because of the reflected RF wave features and behavior, and because it may occur that the signal will vary with time. This is an assumption of the inventors, and one reason that the inventors have found the division into frames to be advantageous.

d. Shape Imitation Process:

The shape imitating process re-samples the signal by an f factor which defines the “skip” length along the wave. This factor may be determined after tests and simulations. This process enables excepting the exact wave shape in a fast and accurate manner without squaring the wave. The re-sample points (x and y values) are stored and coded.

The shape imitation process results in a matrix size of (M×[N/factor]).

e. Frames Correlation:

This process, in similarity to the previous processes, also utilizes the unique form of each reflected RF signal by correlating between the sampled frames. Considering the fact that the frames have a unique interaction to one another this process determines the cross-correlation between them. This process estimates the cross-correlation sequence of a random process.

The true cross-correlation sequence is:

R_{XY}(m)=E{Xₙ₊ₘ·Y*ₙ}=E{Xₙ·Y*ₙ₋ₘ} (11)

Wherein Xn and Yn are different frames of the signal and theoretically jointly stationary random processes, with length N. E is the expected value operator.

The Frames correlation returns the cross-correlation sequence in a length 2*N−1 vector.

$${\hat{R}}_{XY} ( m ) = \{ \begin{matrix}{\sum }_{n = 0}^{N - m - 1} {X}_{n + m} \cdot {Y}_{n}^{*} , & m \geq 0 \\ {\hat{R}}_{YX}^{*} ( - m ) , & m < 0\end{matrix} \} \qquad ( 12 )$$

The output vector has elements given by Rxy(m−N), m=1 . . . 2N−1. Finally, the sequence may be normalized so that the correlations coefficients will be between 0 and 1, and at zero lag are identically 1.

In that case, the correlation matrix size is (M×[2*N−1]).

Frequency Domain:

f. Fast Fourier Transform (FFT):

This process implements the transform pair given for vectors of length N by:

$$\begin{matrix}S ( k ) = {\sum }_{n = 1}^{N} s ( n ) {w}_{N}^{( n - 1 ) ( k - 1 )} & ( 13 ) \\ s ( n ) = ( 1 / N ) {\sum }_{k = 1}^{N} S ( k ) {w}_{N}^{- ( n - 1 ) ( k - 1 )} & ( 14 )\end{matrix}$$

Where: W_{N}=exp(−2·πi)/N is an Nth root of unity.

To compute an N-point DFT when N is composite (when N=N₁·N₂) This decompose the problem using the Cooley-Tukey algorithm, which first computes N₁ transforms of size, and then computes N₂ transforms of size. The decomposition is applied recursively to both the N₁- and N₂-point DFTs until the problem can be solved using one of several machine-generated fixed-size “codelets.” The codelets in turn use several algorithms in combination, including a variation of Cooley-Tukey, a prime factor algorithm, and a split-radix algorithm. The particular factorization of N is chosen heuristically. The execution time for FFT depends on the length of the transform. It is fastest for powers of two. The inventors have found in their tests better results with ft factor (ft=512, 9 power of 2).

The resulted FFT matrix has a size of (M×ft).

g. Phase (Using Simulink):

Simulink® is an environment for multi-domain simulation and Model-based Design for dynamic and embedded systems. It provides an interactive graphical environment and a customizable set of block libraries that let you design, simulate, implement, and test a variety of time-varying systems, including communications, controls, signal processing, video processing, and image processing.

The movement of the substrate within the system creates an influence on the reflected RF signal and on the phase measurements. To find the phase characteristic the inventors have used an integrator as follows:

S(t)=∫ₜ_{₀}^{t} s(t)dt+y₀ (15)

Where: s(t) is the reflected RF signal.
y₀ is the initial condition.
t is the current simulation time.

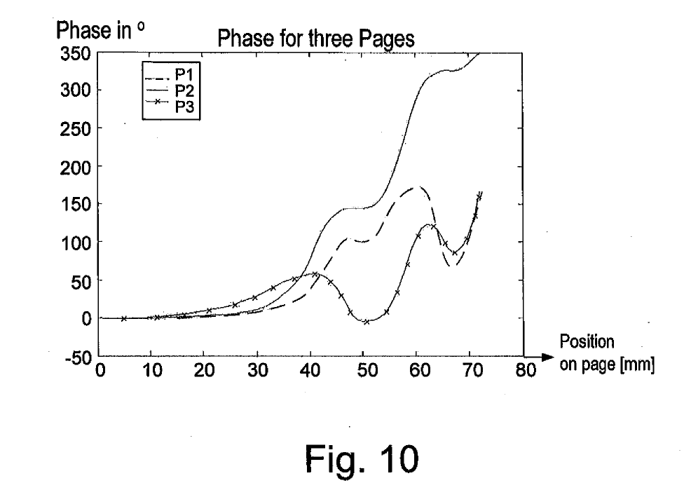

After many tests the inventors have found better results when applying this process on the entire wave, i.e., while not dividing the signal into frames. More specifically, the inventors have tested a same page many times and found that the resulted phase is repeated, i.e., having the same wave signature. FIG. 10 shows the resulted phase, as obtained from three different pages, P1, P2, and P3. These significant results are unquestioned due to the obvious differences between the pages. Although in few rare occasions the phase values were a bit different (up to 8-10 degrees deviation), still the inventors could recognize the same wave signature.

While some embodiments of the invention have been described by way of illustration, it will be apparent that the invention can be carried out with many modifications, variations and adaptations, and with the use of numerous equivalents or alternative solutions that are within the scope of persons skilled in the art, without departing from the spirit of the invention or exceeding the scope of the claims.

1. System for authenticating a printed document, said document being printed on a substrate which includes plurality of electromagnetic responsive targets that are introduced to the substrate during its manufacturing process and randomly distributed therein, and wherein each target having a fiber form, said system comprises an authentication apparatus which comprises:
i. one transmitting antenna and one receiving antenna that are positioned above a moving conveyor, for radiating an original document during a scanning period in which the conveyor moves the document below said transmitting and receiving antennas;
ii. a transmitter for providing electromagnetic signal to said transmitting antenna, and a receiver for receiving from said receiving antenna a responsive electromagnetic signal, said responsive signal being an accumulative response from plurality of said targets as obtained during said scanning period;
iii. a sampling unit for sampling said accumulated responsive signal, thereby to produce a set of signal samples; and
iv. a processing unit for analyzing one or more aspects of said signal samples, resulting with a set of one characterizing matrix for each aspect of said analyzed signal, wherein the collection of all said matrices forms an original set of characterizing matrices that characterize the substrate of this specific document; and
v. a safe storage for storing said original set of characterizing matrices for possible future need for authenticating this specific document.

2. System according to claim 1, wherein the analysis is performed at the time domain, frequency domain, or both.

3. System according to claim 1, wherein the types of analyses comprise one or more of: Zero Crossing Ratio, Linear Predictive Coding, Prony, Shape Imitation Process, Frames Correlation, Fast Fourier Transform, and Phase.

4. Authentication system according to claim 1, wherein the apparatus further comprises an optical scanning unit for optically scanning the printed document, obtaining one or more of optical characterizing matrices which characterize the printed content of the document, and adding said optical characterizing matrices to said original set of characterizing matrices for future comparison.

5. Authentication system according to claim 1, further comprising an authentication processing center, which comprises:
i. an authentication apparatus as in claim 1 for scanning a document at a later date and obtaining a later set of characterizing matrices;
ii. a retrieval unit for retrieving said original set of characterizing matrices from said safe storage; and
iii. a comparator for comparing said later set of characterizing matrices with said original set of characterizing matrices that presumably corresponds to a same document, and if a similarity above a predefined threshold is found, declaring said scanned document as authentic, otherwise declaring the scanned document as non-authentic.

6. System according to claim 5, wherein the authentication apparatus which performs the original examination of the document further stamps the original document with document code for ensuring a reliable future retrieval of the original set of characterizing matrices and reliable comparison, and wherein said document code comprises one or more of:
i. the apparatus version by which the original examination was performed;
ii. the serial number of the original examining apparatus;
iii. a serial number of the authentic original document;
iv. the date of examination;
v. an integrity index.

7. System according to claim 6, wherein the document code is visually seen.

8. System according to claim 6, wherein the document code has a form selected from the group of barcode or alphanumeric.

9. System according to claim 5, wherein the authentication processing center is located remote from said safe storage, and wherein the characterizing matrices are transferred for comparison via a secured link.

10. System according to claim 5, wherein the comparison is performed at the location of the safe storage, or at the location of the authentication processing center.

11. System according to claim 1, wherein the frequency of the transmitting signal is in the range of 24 GHz or 60 GHz.

12. System according to claim 1, wherein the sampling rate is at least 1 KHz.
